(19) United States
(12) Patent Application Publication
(10) Pub. No.: US 2010/0147957 A1
(43) Pub. Date: Jun. 17, 2010

(54) Range finding in imaging reader for electro-optically reading indicia

(76) Inventor: Vladimir Gurevich, Stoney Brook, NY (US)

Correspondence Address: MOTOROLA, INC., 1303 EAST ALGONQUIN ROAD, IL01/3RD, SCHAUMBURG, IL, 60196, US

(21) Appl. No.: 12/316,843

(22) Filed: Dec. 17, 2008

(51) Int. Cl. G06K 7/10

(52) U.S. Cl. 235/472.03

(57) ABSTRACT

An aiming light assembly of an imaging reader projects on a target, during an aiming mode of operation, an aiming light pattern that varies as a function of distance between a movable housing and the target. A solid-state imager captures light from the aiming light pattern during the aiming mode, and generates an electrical distance signal indicative of a target distance between the housing and the target. The imager also captures return light over a field of view from the target during a reading mode of operation after the aiming mode, and generates an electrical target signal indicative of the target. A controller processes the electrical distance signal during the aiming mode into data indicative of the target distance, and also processes the electrical target signal during the reading mode into data indicative of the target located at the target distance.

### BACKGROUND OF THE INVENTION

Solid-state imaging readers have been used in supermarkets, warehouse clubs, department stores, and other kinds of retailers to capture light from various targets, for example, to electro-optically read one-dimensional bar code symbols, particularly of the Universal Product Code (UPC) type, on products to be purchased, each symbol having a row of bars and spaces spaced apart along one direction, and also for processing two-dimensional symbols, such as Code 49, as well as to capture light from other non-symbol targets. The structure of Code 49, which introduced the concept of vertically stacking a plurality of rows of bar and space patterns in a single symbol, is described in U.S. Pat. No. 4,794,239. Another two-dimensional symbol that increases the amount of data that can be represented or stored on a given amount of surface area of a target is known as PDF417 and is described in U.S. Pat. No. 5,304,786.

A typical imaging reader includes a solid-state imager having a one- or two-dimensional array of cells or photosensors, which correspond to image elements or pixels in a field of view of the imager, and a focusing lens assembly for capturing light from a target symbol and projecting the captured light onto the imager during an exposure time period. The imager may be a one- or two-dimensional charge coupled device (CCD) or a complementary metal oxide semiconductor (CMOS) device, together with associated electronic circuits for producing electrical signals corresponding to a one- or two-dimensional array of pixel information over the field of view, and is similar to that used in a digital camera. A programmed microprocessor is used for processing and decoding the electrical signals to read each captured image.

The imaging reader further typically includes an illuminator to illuminate the symbol during its reading with illumination light emitted from an illumination light source and directed to the symbol for reflection and scattering as return light therefrom. The illumination light source may be located within and/or externally of the system, and typically comprises one or more light emitting diodes (LEDs). The focusing lens assembly includes fixed and/or adjustable optical elements for capturing the return light, which includes ambient light, over a range of working distances in which the symbol can be located relative to the reader, and successfully read during a reading mode. To assist an operator in locating and reading a desired symbol, the imaging reader is often equipped with an aiming assembly having an aiming light source, e.g., an aiming laser for generating a laser beam, and aiming optics for generating a visible aiming pattern, such as a “crosshair” pattern, from the laser beam. The operator trains the aiming pattern on the symbol to be imaged during an aiming mode prior to the reading mode.

It is therefore known to use a solid-state imaging reader for capturing a monochrome image of a symbol as, for example, disclosed in U.S. Pat. No. 5,703,349. It is also known to use a solid-state imaging reader with multiple buried channels for capturing a full color image of the symbol as, for example, disclosed in U.S. Pat. No. 4,613,895. It is common to provide a two-dimensional CCD with a 640×480 resolution commonly found in VGA monitors, although other resolution sizes are possible.

For optimum reading performance of imaging readers, especially hand-held movable readers, it is desirable to determine the range or distance between the reader and the target symbol to be read. This distance information is useful for many purposes. For example, this distance information can be used to set the intensity level of the illumination light emitted from the illumination light source, since a higher intensity level is better for illuminating a far-out symbol located further from the reader than a close-in symbol. This distance information can also be used to set the exposure time period that the imager is enabled to capture the return light, since a longer exposure time period is better for capturing more of the return light from the far-out symbol than from the close-in symbol. In addition, this distance information can be used to set the gain of the electronic circuits associated with the imager, since a higher gain is better for increasing the amplitude of the electrical signal generated from the far-out symbol than from the close-in symbol. This distance information can also be used to select an optimum decoding algorithm, i.e., one for processing the far-out symbol, and another for processing the close-in symbol. Most often, this distance information is used to adjust the focal or imaging plane of the adjustable optical elements of the focusing lens assembly in an automatic focusing system.

One known way to determine the distance between the reader and the symbol is to use a rangefinder. However, this approach adds component and manufacturing expense. Another way measures the parallax between the imaging axis of the imager and the aiming axis of the aiming assembly. However, this approach requires system calibration is to know which photosensor of the imager is located on the imaging axis. Also, each reader needs to be calibrated since the location of a central photosensor of the imager varies widely from one reader to the next. Still further, sometimes it is undesirable to require parallax to be deliberately designed into the reader.

Still another way to determine the distance between the reader and the symbol is to equip the aiming assembly with two aiming lasers, as described in U.S. patent application Ser. No. 11/807,943, filed May 30, 2007, the entire contents of which are hereby incorporated herein by reference thereto, in which the operator is visually guided to an optimum working distance by an aiming pattern on the symbol. Although generally satisfactory for its intended purpose, this approach adds component and manufacturing expense, as well as system complexity.

Yet another way to determine the distance between the reader and the symbol is to pulse an aiming laser, and to measure the travel time of the laser pulse. However, this approach reduces the brightness or intensity level of the aiming pattern, as well as of the return light, and requires complex high-speed electronic circuitry. Accordingly, it would be desirable to determine the distance between the reader and the symbol without using a discrete rangefinder, without using parallax, without using a pair of aiming lasers, and without pulsing a single laser and measuring laser pulse travel times with complex high-speed electronic circuitry.

### SUMMARY OF THE INVENTION

One feature of the present invention relates, briefly stated, to an imaging reader for, and a method of, imaging a target, especially one-dimensional symbols and/or two-dimensional symbols, to be electro-optically decoded and read during a reading mode of operation. The reader is preferably embodied as a portable, point-of-transaction, gun-shaped, handheld housing, but could be embodied as a handheld, box-shaped housing, or the like. Prior to reading of the symbols, the reader is brought to, and aimed at, the symbols by an operator during an aiming mode of operation. In the preferred embodiment, the reader is installed in a retail establishment, such as a supermarket, but can be installed virtually anywhere requiring symbols to be read.

A one- or two-dimensional, solid-state imager under control of a controller or programmed microprocessor is mounted in the reader, and includes an array of image sensors operative for capturing return light from the symbol during the reading mode over a field of view, and for generating an electrical target signal indicative of the captured light. The controller is also operative for processing the electrical target signal into data indicative of the symbol being read. Preferably, the array is a charge coupled device (CCD) or a complementary metal oxide semiconductor (CMOS) device. An imaging lens assembly is preferably mounted in the reader in front of the imager to focus and project the captured light onto the imager.

The imager may be associated with an illumination assembly under control of the controller to illuminate the symbol and enable image capture to be acquired in a very short period of time, for example, on the order of 500 microseconds, so that the image is not blurred even if there is relative motion between the imager and the symbol. The illumination light is preferably brighter than ambient light. The illumination light can also be continuous. The imager is exposed by the controller and captures light over an exposure time period, also under the control of the controller. A short exposure time period also prevents image blurring.

In accordance with one feature of this invention, an aiming light assembly is supported by the housing, and is operative, during the aiming mode of operation, for projecting on the symbol an aiming light pattern or light distribution, as described below, that varies as a function of distance between the housing and the symbol. The imager is also operative, during the aiming mode, for capturing light from the aiming light pattern, and for generating an electrical distance signal indicative of a target distance between the housing and the target. The controller is also operative, during the aiming mode, for processing the electrical distance signal into data indicative of the target distance. The aiming light pattern is turned off during the reading mode.

In a preferred embodiment, the aiming light assembly includes a laser for emitting a laser beam, a collimating element for collimating the laser beam to form a collimated beam, and a pattern shaping optical element, such as a diffractive or a refractive optical element, for modifying the collimated beam to form the aiming light pattern as a pair of spots on the symbol. The pattern shaping optical element modifies the collimated beam to form a pair of sub-beams that converge in an outward direction away from the housing. The pattern shaping optical element spaces the pair of spots apart on the symbol by a spacing that is a maximum at the pattern shaping optical element, and overlaps the pair of spots at a focal plane of the pattern shaping optical element. The spacing decreases in the outward direction from the pattern shaping optical element to the focal plane of the pattern shaping optical element.

Advantageously, an imaging lens assembly is also supported by the housing and is operative for imaging the pair of spots onto the imager at a separation distance. The controller measures the separation distance on the imager to determine the target distance. The imager captures the return light during the exposure time period. The controller continuously energizes the laser during the exposure time period.

The method of imaging targets is performed by moving a housing by an operator; projecting on a target, during an aiming mode of operation, an aiming light pattern that varies as a function of distance between the housing and the target; capturing light from the aiming light pattern with a solid-state imager during the aiming mode, and generating an electrical distance signal indicative of a target distance between the housing and the target; processing the electrical distance signal during the aiming mode into data indicative of the target distance; capturing return light over a field of view of the imager from the target during a reading mode of operation after the aiming mode, and generating an electrical target signal indicative of the target; and processing the electrical target signal during the reading mode into data indicative of the target located at the target distance.

Thus, in accordance with an aspect of this invention, the distance between the reader and the symbol is determined without using a discrete rangefinder, without using parallax, without using a pair of aiming lasers, and without pulsing a single laser and measuring laser pulse travel times with complex high-speed electronic circuitry. This distance information can be used, as described above, to set the intensity level of the illumination light emitted from the illumination light source, and/or to set the exposure time period that the imager is enabled to capture the return light, and/or to set the gain of the electronic circuits associated with the imager, and/or to select an optimum decoding algorithm, and/or to adjust the focal or imaging plane of the adjustable optical elements of the focusing lens assembly in an automatic focusing system, and so on.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of an imaging reader for electro-optically reading symbols by image capture;

FIG. 2 is a diagrammatic plan view of components within the reader of FIG. 1 including components of an imaging assembly and an aiming light assembly in accordance with this invention;

FIG. 3 is a diagrammatic view of the aiming light assembly of FIG. 2 during the aiming mode; and

FIG. 4 is a diagrammatic view of the imaging assembly of FIG. 2 during the aiming mode.

### DETAILED DESCRIPTION OF THE PREFERRED EMBODIMENTS

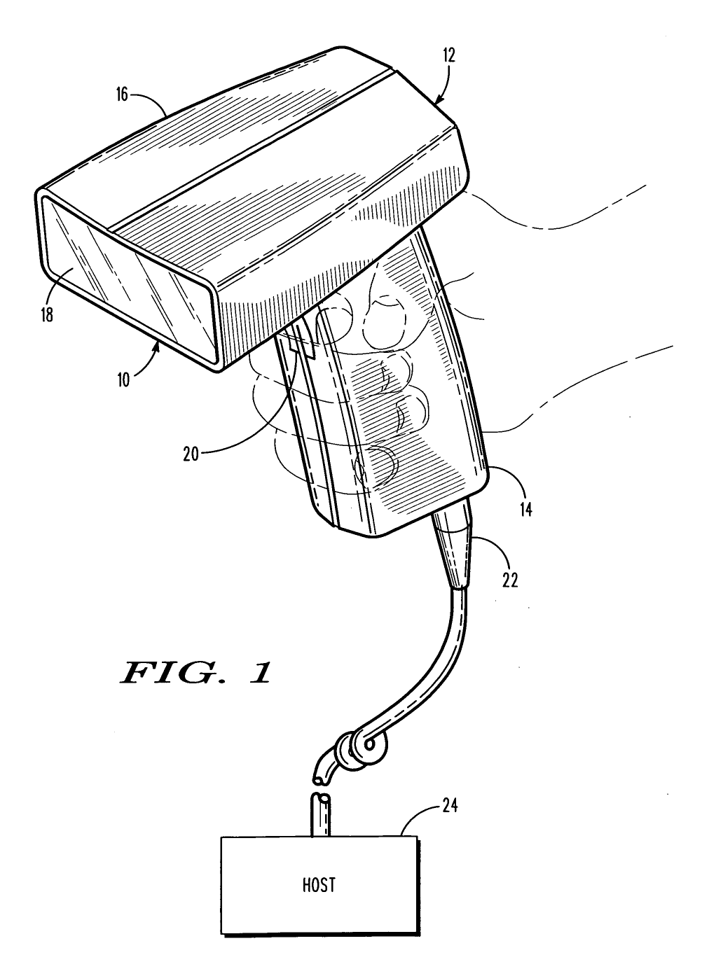

Reference numeral 10 in FIG. 1 generally identifies a handheld imaging reader for electro-optically reading symbols or like indicia on products or like targets. The reader 10 includes a housing 12 in which an aiming light assembly, as described in detail below in accordance with this invention, is incorporated. The housing 12 includes a generally elongated handle or lower handgrip portion 14 and a barrel or upper body portion 16 having a front end at which a light-transmissive window 18 is located. The cross-sectional dimensions and overall size of the handle are such that the reader can conveniently be held in an operator's hand.

The body and handle portions may be constructed of a lightweight, resilient, shock-resistant, self-supporting material such as a synthetic plastic material. The plastic housing may be injection molded, but can be vacuum-formed or blow-molded to form a thin hollow shell which bounds an interior space whose volume is sufficient to contain the various components of this invention.

A manually actuatable trigger 20 is mounted in a moving relationship on the handle 14 in a forward facing region of the reader. The operator's forefinger is used to actuate the reader to initiate reading by depressing the trigger. An optional flexible electrical cable 22 is provided to connect the reader to a remote host 24. The cable may also provide electrical power to the reader. The host 24 has access to a database for retrieval of information. If the cable 22 is not used, then a wireless link to transfer data may be provided between the reader 10 and the host 24, and an on-board battery, typically within the handle 14, can be used to supply electrical power.

An alternative embodiment incorporates a display and a keyboard. Data obtained from reading the symbols is then either transferred to the remote host 24 in real time, or saved to an internal memory such that the stored data can be transferred to the host 24 at a later time in batch mode.

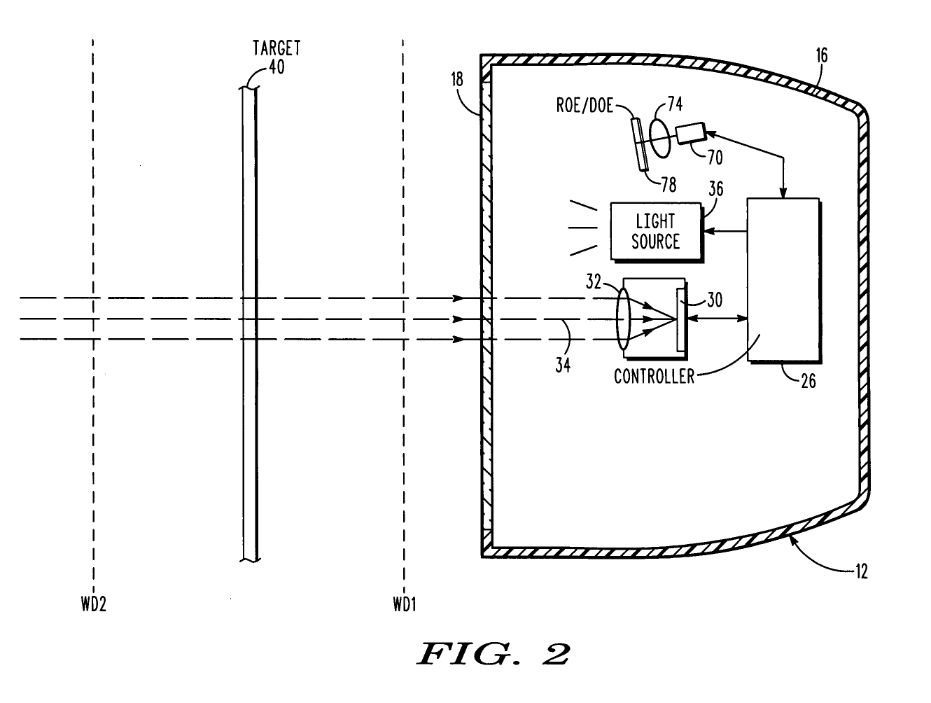

A solid-state imager 30, as shown in the interior plan view of FIG. 2, is mounted within the housing 12 and preferably is a one- or two-dimensional, charge coupled device (CCD) or complementary metal oxide semiconductor (CMOS) array of cells or sensors operative for capturing light over its field of view from a target, such as a symbol 40, through the window 18 and focused by an imaging lens assembly 32 onto the imager 30 during a reading mode of operation. The sensors produce electrical target signals corresponding to a one- and/or two-dimensional array of pixel information indicative of an image of the symbol 40. The electrical target signals are processed by a controller or microprocessor 26 into data indicative of the symbol 40 being read.

The imager 30 and the imaging lens assembly 32 are preferably aligned along a centerline or an imaging axis 34 generally centrally located within the body portion 16. The imaging lens assembly 32 preferably has a variable focus and enables image capture over a range of working distances between a close-in distance WD1 and a far-out distance WD2 relative to the window 18. The close-in distance WD1 can be at, or a few inches away from, the window 18. The far-out distance WD2 can be many feet away from the window 18. The imager 30 and the imaging lens assembly 32 are capable of acquiring a full image of the symbol 40 in lighting conditions from two lux to direct sunlight. Exposure time is about 15-33 milliseconds and controlled by the controller 26. Resolution of the array can be of various sizes although a VGA resolution of 640×480 pixels is preferred.

An illumination light source 36 for the imager 30 is also provided to provide an illumination field for the imager. The source 36 preferably constitutes one or a plurality of light emitting diodes (LEDs) energized by power supply lines in the cable 22, or via the on-board battery. The source 36 is energized in synchronism with the imager 30 under the control of the controller 26 during an exposure time period.

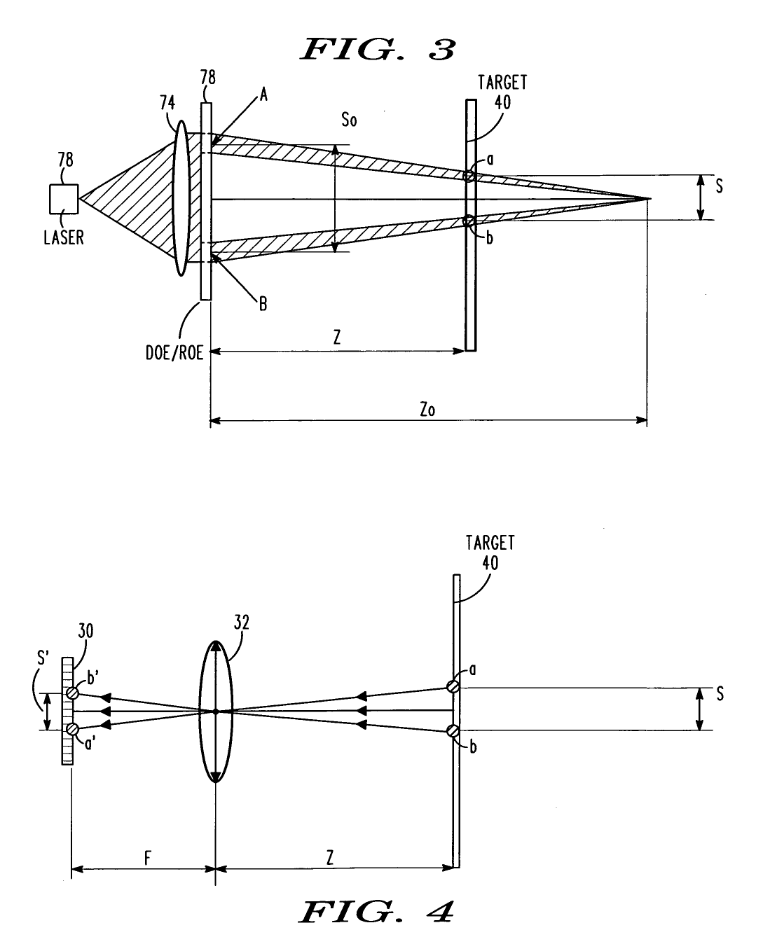

In accordance with one feature of this invention, the aiming light assembly is supported by the housing 12, as depicted in FIG. 2, and is operative, during an aiming mode of operation prior to the reading mode, for projecting on the symbol 40 an aiming light pattern or light distribution, e.g., a pair of light spots “a” and “b” as described below in connection with FIGS. 3 and 4, that varies as a function of distance “Z” between the housing 12 and the symbol 40. The imager 30 is also operative, during the aiming mode, as described below in connection with FIG. 4, for capturing light from the aiming light pattern, and for generating an electrical distance signal indicative of a target distance “Z” between the housing 12 and the symbol 40. The controller 26 is also operative, during the aiming mode, for processing the electrical distance signal into data indicative of the target distance. The aiming light pattern is turned off during the reading mode.

In a preferred embodiment, the aiming light assembly includes a laser 70 for emitting a laser beam, a collimating element 74 for collimating the laser beam to form a collimated beam, and a pattern shaping optical element 78, such as a diffractive optical element (DOE), or a refractive optical element (ROE), for modifying the collimated beam to form the aiming light pattern as the pair of spots “a” and “b” on the symbol. The pattern shaping optical element 78 modifies the collimated beam to form a pair of sub-beams that converge in an outward direction away from the housing 12 and is focused at a focal plane “Zₒ”.

For this focusing purpose, the pattern shaping optical element 78 includes a pair of zones or masks “A” and “B”. These zones are generally planar, light-transmissive areas surrounded by micro-structures arranged in a diffractive or a refractive optical pattern. These micro-structures are used to form multiple diverging beamlets, as described in U.S. Pat. No. 6,340,114, and a detailed analysis of a refractive optical element or lens suitable for use in shaping a laser beam is found in U.S. Pat. No. 7,182,260. A detailed analysis of a diffractive optical element or lens for use in shaping a laser beam is found in U.S. Pat. No. 6,021,106.

The pattern shaping optical element 78 spaces the pair of spots “a” and “b” apart on the symbol 40 located at a target distance “Z” by a spacing “S” that is a maximum “Sₒ” at the pattern shaping optical element 78. As shown in FIG. 3, the pair of spots “a” and “b” overlaps at the focal plane “Zₒ” of the pattern shaping optical element78. The spacing “S” decreases in the outward direction from the pattern shaping optical element 78 to the focal plane “Zₒ” of the pattern shaping optical element 78. The spacing “S” depends on the target distance “Z” and can be mathematically expressed as:

S=Sₒ*(Zₒ−Z)/Zₒ

As shown in FIG. 4, the imaging lens assembly 32 is spaced at a distance “F” from the imager 30, and is operative for imaging the pair of spots “a” and “b” on the symbol 40 as spot images a′ and b′ on the imager 30 at a separation distance S′. The separation distance S′ also depends on the target distance “Z” and can be mathematically expressed as:

S′=S*F/Z=Sₒ*F*(1/Z−1/Zₒ)

The controller 26 measures the separation distance S′ on the imager 30 to determine the target distance Z. The target distance Z can be determined from the separation distance S′ by the following equation:

Z=1/(S′/F/Sₒ+1/Zₒ)

The controller 26 can rapidly determine the separation distance S′ during the aiming mode by only looking at a partial frame of the data, that is, a partial region of the imager, which is smaller than the field of view of the imager, at which the images a′ and b′ are expected.

In another embodiment, rather than using the pattern shaping optical element 78, the aiming light assembly includes a laser 70 that has astigmatism, which occurs when the vertical and horizontal parts of the laser beam focus in different locations along the beam path to the target. The astigmatic beam projects on the target an aiming light pattern or beam cross-section that varies as a function of the target distance between the housing and the target. This variable beam cross-section is imaged onto the imager, and its size along the vertical and horizontal parts of the beam cross-section can be measured by the controller, thereby determining the target distance.

It will be understood that each of the elements described above, or two or more together, also may find a useful application in other types of constructions differing from the types described above. Thus, readers having different configurations can be used.

While the invention has been illustrated and described as range finding in an imaging reader, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. An imaging reader for imaging targets, comprising:
a housing movable by an operator;
an aiming light assembly supported by the housing and operative, during an aiming mode of operation, for projecting on a target an aiming light pattern that varies as a function of distance between the housing and the target;
a solid-state imager supported by the housing and operative, during the aiming mode, for capturing light from the aiming light pattern and for generating an electrical distance signal indicative of a target distance between the housing and the target, and operative, during a reading mode of operation after the aiming mode, for capturing return light over a field of view from the target and for generating an electrical target signal indicative of the target; and
a controller operative, during the aiming mode, for processing the electrical distance signal into data indicative of the target distance, and operative, during the reading mode, for processing the electrical target signal into data indicative of the target located at the target distance.

2. The reader of claim 1, wherein the aiming light assembly includes a laser for emitting a laser beam, a collimating element for collimating the laser beam to form a collimated beam, and a pattern shaping optical element for modifying the collimated beam to form the aiming light pattern as a pair of spots on the target.

3. The reader of claim 2, wherein the pattern shaping optical element modifies the collimated beam to form a pair of sub-beams that converge in an outward direction away from the housing.

4. The reader of claim 3, wherein the pattern shaping optical element spaces the pair of spots apart on the target by a spacing that is a maximum at the pattern shaping optical element, and overlaps the pair of spots at a focal plane of the pattern shaping optical element; and wherein the spacing decreases in the outward direction from the pattern shaping optical element to the focal plane of the pattern shaping optical element.

5. The reader of claim 4, and an imaging lens assembly supported by the housing and operative for imaging the pair of spots onto the imager at a separation distance, and wherein the controller measures the separation distance on the imager to determine the target distance.

6. The reader of claim 2, wherein the imager captures the return light during an exposure time period, and wherein the controller continuously energizes the laser during the exposure time period.

7. The reader of claim 1, wherein the imager is one of a charge coupled device and a complementary metal oxide silicon device, and wherein the target is a symbol that is one of a one-dimensional symbol and a two-dimensional symbol.

8. An imaging reader for imaging targets, comprising:
housing means movable by an operator;
aiming means supported by the housing means and operative, during an aiming mode of operation, for projecting on a target an aiming light pattern that varies as a function of distance between the housing means and the target;
imaging means supported by the housing means and operative, during the aiming mode, for capturing light from the aiming light pattern and for generating an electrical distance signal indicative of a target distance between the housing means and the target, and operative, during a reading mode of operation after the aiming mode, for capturing return light over a field of view from the target and for generating an electrical target signal indicative of the target; and
control means operative, during the aiming mode, for processing the electrical distance signal into data indicative of the target distance, and operative, during the reading mode, for processing the electrical target signal into data indicative of the target located at the target distance.

9. The reader of claim 8, wherein the aiming means includes means for emitting a laser beam, means for collimating the laser beam to form a collimated beam, and means for modifying the collimated beam to form the aiming light pattern as a pair of spots on the target.

10. The reader of claim 9, wherein the modifying means modifies the collimated beam to form a pair of sub-beams that converge in an outward direction away from the housing means .

11. The reader of claim 10, wherein the modifying means spaces the pair of spots apart on the target by a spacing that is a maximum at the modifying means, and overlaps the pair of spots at a focal plane of the modifying means; and wherein the spacing decreases in the outward direction from the modifying means to the focal plane of the modifying means.

12. The reader of claim 11, and means for imaging the pair of spots onto the imaging means at a separation distance, and wherein the control means measures the separation distance on the imaging means to determine the target distance.

13. A method of imaging targets, comprising the steps of:
moving a housing by an operator;
projecting on a target , during an aiming mode of operation, an aiming light pattern that varies as a function of distance between the housing and the target;
capturing light from the aiming light pattern with a solid-state imager during the aiming mode, and generating an electrical distance signal indicative of a target distance between the housing and the target;
processing the electrical distance signal during the aiming mode into data indicative of the target distance;
capturing return light over a field of view of the imager from the target during a reading mode of operation after the aiming mode, and generating an electrical target signal indicative of the target; and
processing the electrical target signal during the reading mode into data indicative of the target located at the target distance.

14. The method of claim 13, wherein the projecting step is performed by emitting a laser beam, collimating the laser beam to form a collimated beam, and modifying the collimated beam to form the aiming light pattern as a pair of spots on the target.

15. The method of claim 14, wherein the modifying step is performed by modifying the collimated beam to form a pair of sub-beams that converge in an outward direction away from the housing.

16. The method of claim 15, wherein the modifying step is performed by spacing the pair of spots apart on the target by a spacing that is a maximum at the housing, and by overlapping the pair of spots at a focal plane away from the housing, and by decreasing the spacing in the outward direction from the housing to the focal plane.

17. The method of claim 16, and imaging the pair of spots onto the imager at a separation distance, and measuring the separation distance on the imager to determine the target distance.

18. The method of claim 14, wherein the step of capturing the return light is performed during an exposure time period, and wherein the laser beam is continuously emitted during the exposure time period.

19. The method of claim 13, and configuring the imager to be one of a charge coupled device and a complementary metal oxide silicon device, and configuring the target to be a symbol that is one of a one-dimensional symbol and a two-dimensional symbol.
